(19) United States
(12) Patent Application Publication
(10) Pub. No.: US 2016/0255392 A1
(43) Pub. Date: Sep. 1, 2016

(54) REMOTE CONTROL APPARATUS AND SMART TV

(71) Applicant: (LE SHI ZHI XIN ELECTRONIC TECHNOLOGY (TIANJIN) LIMITED), Beijing (CN)

(72) Inventors: Zhen LI, Beijing (CN); Fan LIANG, Beijing (CN)

(21) Appl. No.: 15/032,619

(22) PCT Filed: Oct. 29, 2014
(86) PCT No.: PCT/CN2014/089779

§ 371 Date: Apr. 27, 2016

(30) Foreign Application Priority Data
Oct. 30, 2013 (CN) 201310530270.9

(51) Int. Cl. H04N 21/422; H04N 21/61

(52) U.S. Cl. CPC H04N 21/42221; H04N 21/6125; H04N 21/42225; H04N 2005/4426

(57) ABSTRACT

The present disclosure discloses a remote control apparatus, including a first data transmission link establishment module, a second data transmission link establishment module, a first control module and a second control module. By using the first control module, a communication control connection established by the first data transmission link establishment module can realize a basic control operation with a media output device, such as TV or radio switching and volume adjusting; and by using the second control module, a data information transmission connection established by the second data transmission link establishment module can send data information to a media output device, such as sending video information to the media output device for playing, so that the media output device outputs the data information after receiving the same. Therefore, the remote control apparatus provided by the present disclosure expands the diversified operation with the media output device and improves user experience.

### CROSS-REFERENCE TO RELATED APPLICATIONS

The present disclosure is a national stage of International Application No. PCT/CN2014/089779, filed Oct. 29, 2014, which is based upon and claims priority to Chinese Patent Application No. CN2013105302709 with the title of Remote Control Apparatus and Smart TV, filed on Oct. 30, 2013, the entire contents of all of which are incorporated herein by reference.

### FIELD OF TECHNOLOGY

The present disclosure generally relates to the technical field of communication, and in particular to a remote control apparatus and a smart TV.

### BACKGROUND

With the constant development of science and technology, a remote controller as a control element has been widely applied to a variety of industries. However, its simple control function has been far from meeting the diversified requirements of users. For example, an existing remote controller is only available for a media output device, such as switching of a television or radio program and adjusting of volume, and if a user wants to remotely control the television through a mobile phone and sends a video currently played by the mobile phone to the television for playing, both are impossible.

Therefore, there are great limitations in terms of interaction between the remote controller and the media output device in the prior art, and it is highly desirable for a device capable of realizing diversified controls over the media output device.

### SUMMARY

In view of the problem described above, the present disclosure provides a remote control apparatus and a smart TV to solve the problem of great limitations existing in terms of the interaction between the remote controller and the television in the prior art. A technical solution is as follows:

Based on an aspect of the present disclosure, there is provided a remote control apparatus applied to smart control area, including:

a first data transmission link establishment module, configured to establish a communication control connection between the remote control apparatus and a media output device that is located under a same local area network with the remote control apparatus and meets a first precondition;

a second data transmission link establishment module, configured to establish a data information transmission connection between the remote control apparatus and a media output device that is under a same local area network with the remote control apparatus and meets a second precondition;

a first control module, which is configured to send a control instruction to the media output device by using an established first data transmission link corresponding to the media output device so as to control the media output device to execute the control instruction; and a second control module, which is configured to send data information to the media output device by using an established second data transmission link corresponding to the media output device so as to allow the media output device to output the data information after receiving the same.

In an embodiment of the present disclosure, further including:

a detection module, configured to detect the media output device that is located under the same local area network with the remote control apparatus and meets the first and/or second precondition;

a determination module, configured to determine at least one of the media output devices detected by the detection module as a target media output device; and

an acquisition module, configured to acquire device information of the target media output device, the device information at least including a physical address of the target media output device,

wherein the first data transmission link establishment module is configured to send a communication control connection request to the target media output device by using the physical address of the target media output device, contained in the device information acquired by the acquisition module, so as to establish a first data transmission link with the target media output device; and

the second data transmission link establishment module is configured to send a data information transmission connection request to the target media output device by using the physical address of the target media output device, contained in the device information acquired by the acquisition module, so as to establish the second data transmission link with the target media output device.

In an embodiment of the present disclosure, wherein the detection module includes:

a first device detection module, configured to detect an electronic device located under the same local area network with the remote control apparatus;

a first judgment module, configured to judge whether the electronic device detected by the first device detection module is a universal plug and play (UPNP) device with a preset identity; and

a first result acquisition module, configured to acquire a first judgment result when the first judgment module judges that the electronic device detected by the first device detection module is a UPNP device with a preset identity,

wherein the determination module is configured to determine that a media output device meeting a precondition is detected when the first judgment result indicates the electronic device being the UPNP device.

In an embodiment of the present disclosure, wherein the detection module includes:

a second device detection module, configured to detect an electronic device located under the same local area network with the remote control apparatus;

a second judgment module, configured to judge whether the electronic device detected by the second device detection module is an electronic device supporting a preset media transmission protocol; and

a second result acquisition module, configured to acquire a second judgment result when the second judgment module judges that the detected electronic device located under the same local area network with the remote control apparatus is an electronic device supporting a preset media transmission protocol;

wherein the determination module is configured to determine that a media output device meeting a precondition is detected when the second judgment result indicates the electronic device being the electronic device supporting the preset media transmission protocol.

In an embodiment of the present disclosure, wherein the detection module further includes:

a third judgment module, configured to judge whether the detected electronic device located under the same local area network with the remote control apparatus is an electronic device supporting a preset media transmission protocol;

a third result acquisition module, configured to acquire a third judgment result when the third judgment module judges that the detected electronic device located under the same local area network with the remote control apparatus is an electronic device supporting a preset media transmission protocol;

a fourth result acquisition module, configured to acquire a physical address of the detected UPNP device and a physical address of the electronic device supporting the preset media transmission protocol when the third judgment result indicates the electronic device being the electronic device supporting the preset media transmission protocol; and

a comparison module, configured to compare whether the physical address of the UPNP device and the physical address of the electronic device supporting the preset media transmission protocol are the same,

wherein the determination module is configured to determine that a media output device meeting a precondition is detected when the physical address of the UPNP device and the physical address of the electronic device supporting the preset media transmission protocol are the same under the comparison of the comparison module.

In an embodiment of the present disclosure, further including:

a data storage module, configured to store data information of local resources of the remote control apparatus;

and/or

a data acquisition module, configured to acquire data information from a local area network.

In an embodiment of the present disclosure, wherein the control instruction may be at least one of a radio switching instruction, a volume adjusting instruction, a menu instruction, a determination instruction or a return instruction.

In an embodiment of the present disclosure, wherein the data information may include at least one of picture information, video information or voice information.

Based on another aspect of the present disclosure, there is provided a smart TV applied to smart control area, including:

a first receiving module, which is configured to receive a control instruction from a remote control apparatus that is located under the same local area network with the smart TV, the control instruction being configured to control the smart TV to execute the control instruction after receiving the same; and

a second receiving module, which is configured to receive data information from a remote control apparatus that is located under the same local area network with the smart TV, the data information being configured to allow the smart TV to output the data information after receiving the same.

In an embodiment of the present disclosure, wherein the first receiving module is a UPNP module with a preset identity; and the second receiving module is a Digital Living Network Alliance (DLNA) network protocol module.

There is further provided a remote control apparatus applied to smart control area, including:

a memory having instructions stored thereon;

a processor configured to execute the instructions to perform operations, including:

establishing a communication control connection between the remote control apparatus and a media output device that is located under a same local area network with the remote control apparatus and meets a first precondition;

establishing a data information transmission connection between the remote control apparatus and a media output device that is under a same local area network with the remote control apparatus and meets a second precondition;

sending a control instruction to the media output device by using an established first data transmission link corresponding to the media output device so as to control the media output device to execute the control instruction; and

sending data information to the media output device by using an established second data transmission link corresponding to the media output device so as to allow the media output device to output the data information after receiving the same.

With application of the technical solution described above, the remote control apparatus provided by the present disclosure expands the diversified operation with the media output device and improves user experience.

### BRIEF DESCRIPTION OF THE DRAWINGS

In order to illustrate technical solutions in the present disclosure more clearly, hereinafter, the Figures which need to be used in describing the embodiments hereinbelow are introduced briefly. Obviously, the Figures described hereinbelow are only some embodiments of the present disclosure, a skilled person in the art may obtain other Figures according to these Figures below without creativity.

FIG. 1 is a schematic diagram of a structure of a remote control apparatus according to the present disclosure.

FIG. 2 is a schematic diagram of another structure of a remote control apparatus according to the present disclosure.

FIG. 3 is a schematic diagram of a structure of a detection module according to the present disclosure.

FIG. 4 is a schematic diagram of another structure of a detection module according to the present disclosure.

FIG. 5 is a schematic diagram of a further another structure of a remote control apparatus according to the present disclosure.

FIG. 6 is a schematic diagram of a structure of a smart TV according to the present disclosure.

### DESCRIPTION OF THE EMBODIMENTS

Hereinafter, the technical solution in the embodiment of the present disclosure is illustrated clearly and completely with the accompanying drawings in the embodiment of the present disclosure. Based on the embodiment of the present disclosure, a skilled person in the art may obtain all the other embodiments without creativity, which are all in the scope of the present disclosure.

The remote control apparatus provided by the present disclosure may possibly be employed either independently as a separate remote control apparatus, or be integrated in other apparatuses. For the purpose of more detailed description, the remote control apparatus referred to in the present disclosure is integrated on a mobile phone as a whole in the each of the following embodiments.

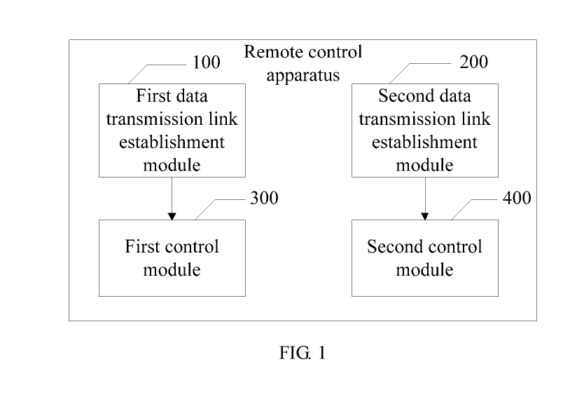

With reference to FIG. 1, it shows a schematic diagram of a structure of a remote control apparatus according to the present disclosure, and the remote control apparatus includes a first data transmission link establishment module 100, a second data transmission link establishment module 200, a first control module 300 and a second control module 400. Wherein:

the first data transmission link establishment module 100 is configured to establish a communication control connection between the remote control apparatus and a media output device that is located under a same local area network with the remote control apparatus and meets a first precondition;

the second data transmission link establishment module 200 is configured to establish a data information transmission connection between the remote control apparatus and a media output device that is under a same local area network with the remote control apparatus and meets a second precondition;

the first control module 300 is configured to send a control instruction to the media output device by using an established first data transmission link corresponding to the media output device so as to control the media output device to execute the control instruction; and

the second control module 400 is configured to send data information to the media output device by using an established second data transmission link corresponding to the media output device so as to allow the media output device to output the data information after receiving the same.

In the present embodiment, the media output device located under the same local area network with the remote control apparatus may include a personal computer, a PAD computer, a smart TV, a smart TV box and the like under the same local area network. The media output device meeting the first precondition as described here refers to the media output device capable of establishing the first data transmission link with the remote control apparatus and receiving as well as executing the control instruction sent by the remote control apparatus. The medial output device meeting the second precondition as described refers to the media output device capable of establishing the second data transmission link with the remote control apparatus and receiving as well as outputting the data information sent by the remote control apparatus. For the purpose of better explanation here, the illustration is now made by taking a remote control phone, formed by integrating the remote control apparatus on a smart phone, and a smart TV as the media output device, as examples.

In the present embodiment, there are two data transmission links between the remote control phone and the smart TV, where the first data transmission link establishment module 100 can be used to realize the communication control connection of the first data transmission link in which the remote control phone corresponds to the smart TV. The communication control connection of the first data transmission link is specifically as follows: the first control module 300 in the remote control phone is used to send a control instruction to the media output device through the established first data transmission link so as to control the media output device to act according to the control instruction for further realizing a basic control operation specific to the smart TV. Wherein, the control instruction may include at least one of a radio switching instruction, a volume adjusting instruction, a menu instruction, a determination instruction or a return instruction. For example, the smart TV is controlled in terms of radio selection, channel switching, volume adjusting, color or grayscale setting and the like. According to the present disclosure, the basic operation between the remote control phone and the smart TV is realized by the first data transmission link established via the first data transmission link establishment module 100.

In the meantime, the second data transmission link establishment module 200 can be used to realize the data information transmission connection of the second data transmission link in which the remote control phone corresponds to the smart TV. The so-called data information transmission connection of the second data transmission link is specifically as follows: the second control module 400 in the remote control phone is used to send data information to the media output device by the established second data transmission link so as to allow the medial output device to output the data information after receiving the same, i.e., transmitting the data information in the remote control phone to the smart TV which further outputs the same continuously. Wherein, the data information may include at least one of picture information, video information or voice information. For example, video data, audio data, picture information and others stored in the remote control phone are transmitted to the smart TV, which continuously outputs the video data, audio data or picture information. Naturally, it is also possible that the video data, audio data, picture information and others acquired by the remote control phone from Internet are transmitted to the smart TV, which further continuously outputs the video data, audio data or picture information. According to the present disclosure, the data information transmission between the remote control phone and the smart TV is realized by the second data transmission link established via the second data transmission link establishment module 200.

With application of the technical solution described above, a remote control apparatus provided by the present disclosure includes a first data transmission link establishment module 100, a second data transmission link establishment module 200, a first control module 300 and a second control module 400. By using the first control module 300, a communication control connection established by the first data transmission link establishment module 100 can realize a basic control operation with a media output device, such as TV or radio switching and volume adjusting; and by using the second control module 400, a data information transmission connection established by the second data transmission link establishment module 200 can be used to send data information to a media output device, such as sending video information to the media output device for playing, so that the media output device outputs the data information after receiving the same. Therefore, the remote control apparatus provided by the present disclosure expands the diversified operation with the media output device and improves user experience.

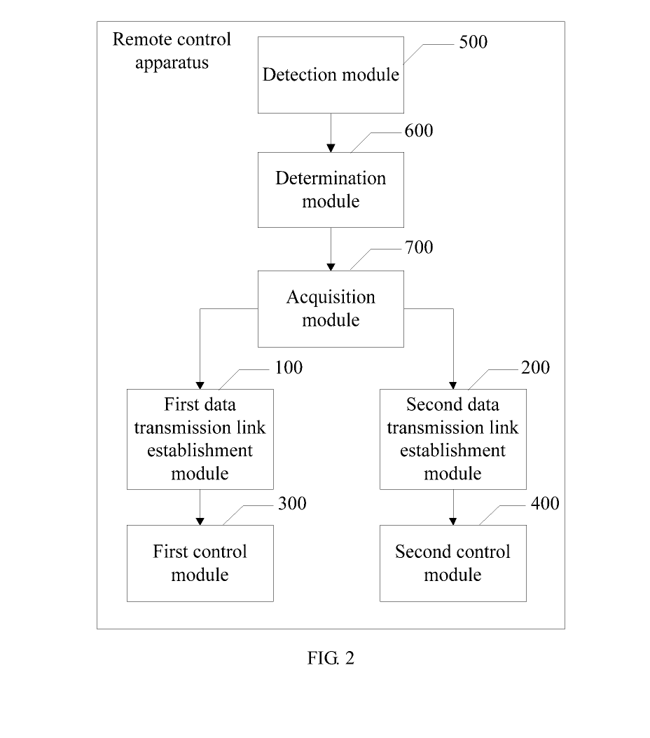

On the basis of the abovementioned embodiment, with reference to FIG. 2, there is provided a schematic diagram of another structure of a remote control apparatus according to the present disclosure, and the remote control apparatus also includes a detection module 500, a determination module 600 and an acquisition module 700. Wherein,

the detection module 500 is configured to detect the media output device that is located under the same local area network with the remote control apparatus and meets the first and/or second precondition;

the determination module 600 is configured to determine at least one of the media output devices detected by the detection module 500 as a target media output device; and

the acquisition module 700 is configured to acquire device information of the target media output device, the device information at least including a physical address of the target media output device.

In this way, the first data transmission link establishment module 100 is specifically configured to send a communication control connection request to the target media output device by using the physical address of the target media output device, contained in the device information acquired by the acquisition module 700, so as to establish the first data transmission link with the target media output device.

The second data transmission link establishment module 200 is specifically configured to send a data information transmission connection request to the target media output device by using the physical address of the target media output device, contained in the device information acquired by the acquisition module 700, so as to establish the second data transmission link with the target media output device.

In the present embodiment, the detection module 500 in the remote control apparatus firstly needs to detect the media output device that is located under the same local area network with the remote control apparatus and meets the first and/or second precondition. The determination module 600 further determines at least one of the media output devices detected by the detection module 500 as a target media output device. Specifically, that the determination module 600 determines at least one of the media output devices as the target media output device may include that: after detecting the media output device available for connection, the detection module 500 displays all the detected media output devices through a display screen for a user to select. When a user selects a media output device, the remote control apparatus then determines the media output device as the target media output device and then treats the target media output device as an object for all the subsequent data interactions; or, the remote control apparatus determines all the detected media output devices as the target media output devices; or, the remote control apparatus determines multiple, such as three, media output devices in order according to the sequence of the detected media output devices, and determines the first three media output devices previously detected, as the target media output devices; or according to the personal setting of the user, the media output devices in compliance with a setting rule of the user are treated as the target media output devices.

In the present embodiment, the remote control phone identifies all the media output devices under the same local area network with the remote control phone via the detection of the detection module 500 and displays them to the user, who then selects the target media output device from all the media output devices, and further, the determination module 600 determines the smart TV as the target media output device.

Specifically, in the present embodiment, that the acquisition module 700 acquires the device information of the target media output device may include receiving broadcast information sent by the target media output device, and the broadcast information includes the device information of the target media output device. Or, a mobile device scans the target media output device in the local area network to directly acquire the physical identity of the target media output device and acquires the device information according to the physical identity.

After selecting the smart TV as the target media output device, the user continuously acquires the device information of the smart TV, where the device information at least includes the physical address of the smart TV. The physical address of the target media output device may be a MAC (Media Access Control) address and the like of the device. In this way, the first data transmission link establishment module 100 sends a communication control connection request to the smart TV by using the physical address of the smart TV so as to establish the first data transmission link with the smart TV. The second data transmission link establishment module 200 sends a data information transmission connection request to the smart TV by using the physical address of the smart TV so as to establish the second data transmission link with the smart TV.

With application of the technical solution of the present disclosure, the remote control apparatus claimed by the present disclosure also includes a detection module 500, a determination module 600 and an acquisition module 700. With the detection module 500, the determination module 600 and the acquisition module 700, the target media output device is determined and the establishment of the first and second data transmission links is facilitated, thereby ensuring the success rate of the communication connection between the remote control apparatus and the target media output device and reducing the probability of occurrence of false connections.

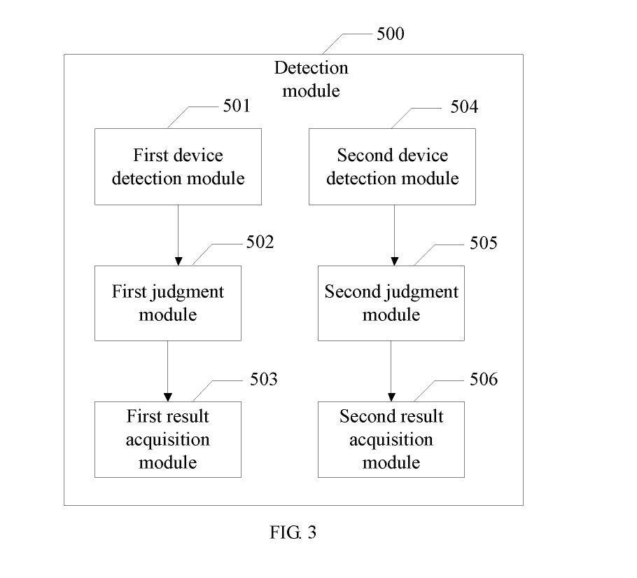

Based on the abovementioned embodiment, with reference FIG. 3, there is provided a schematic diagram of a structure of a detection module according to the present disclosure, and the detection module includes a first device detection module 501, a first judgment module 502, a first result acquisition module 503, a second device detection module 504, a second judgment module 505 and a second result acquisition module 506. Wherein,

the first device detection module 501 is configured to detect an electronic device located under the same local area network with the remote control apparatus;

the first judgment module 502 is configured to judge whether the electronic device detected by the first device detection module 501 is a UPNP (Universal Plug and Play) device with a preset identity; and

the first result acquisition module 503 is configured to acquire a first judgment result when the first judgment module 502 judges that the electronic device detected by the first device detection module 501 is a UPNP device with a preset identity.

In this way, the determination module 600 is specifically configured to determine that the media output device meeting a first precondition is detected when the first judgment result indicates the electronic device being the UPNP device.

Wherein, the UPNP protocol is a network protocol configured to facilitate searching of an electronic device by the remote control apparatus. The electronic device includes the UPNP module so as to be searched by the remote control apparatus. In actual application, each UPNP device is provided with a physical identity configured to be distinguished from other UPNP devices. The identity may include attribute information indicating the property of the UPNP device or user defined device name and the like. In the present embodiment, for instance, judging whether the electronic device is the UPNP device with the preset identity may include judging whether the electronic device is the UPNP device with the device name of “LeTV”, or judging whether the electronic device is the UPNP device with the device name containing “LeTV”.

In the present embodiment, when the first device detection module 501 detects the media output devices that is located under the same local area network with the remote control apparatus and meets the first precondition, a large number of network resources are consumed to search all the media output devices within the local area network for the establishment of the communication control connection of the first data transmission link, and generally, the number of the target media output device desired by the user is only one, or three at most. The establishment of the first data transmission link with all the media output devices searched within the local area network not only consumes a large number of network resources, but also even leads to network congestion to result in network delay. Based on this, for the purpose of efficiently detecting the media output device that is located under the same local area network with the remote control apparatus and meets the first precondition by the remote control apparatus, the remote control apparatus may detect the electronic devices located under the same local area network with the remote control apparatus, judges whether the electronic device is the UPNP (Universal Plug and Play) device with the preset identity and then acquires a first judgment result.

The determination module 6000 determines that the media output device meeting the first precondition is detected when the first judgment result acquired by the first result acquisition module 503 indicates the electronic device being the UPNP device.

Further, in the detection module 500,

the second device detection module 504 is configured to detect an electronic device located under the same local area network with the remote control apparatus; and

the second judgment module 505 is configured to judge whether the electronic device detected by the second device detection module 504 is an electronic device supporting a preset media transmission protocol.

It should be noted that the supported preset media transmission protocol in the present embodiment is a second precondition.

The second result acquisition module 506 is configured to acquire a second judgment result when the second judgment module 505 judges that the detected electronic device located under the same local area network with the remote control apparatus is the electronic device supporting the preset media transmission protocol.

In this way, the determination module 600 is specifically configured to determine that the media output device meeting the second precondition is detected when the second judgment result indicates the electronic device being the electronic device supporting the preset media transmission protocol.

Wherein, the electronic device supporting the preset media transmission protocol refers to a device capable of receiving data information sent by the remote control apparatus and reading as well as processing the data information received. The preset media transmission protocol may be a local area network based data communication protocol, for example, the DLNA (Digital Living Network Alliance) network protocol. In the present embodiment, for example, if the remote control apparatus sends video data to the electronic device, it is desirable for the electronic device to be provided with a module capable of receiving and reading as well as processing the video data. Generally, for the remote control apparatus with an Android system, the electronic device shall be provided with a DMR (Digital Media Receiver) module for receiving the video data sent by the Android system. For the remote control apparatus with an Apple iOS system, the electronic device shall be provided with an AirPlay module for receiving the video data sent by the Apple iOS system. The electronic device with the DMR module and/or the AirPlay module is referred to as the electronic device supporting the preset media transmission protocol.

In the present embodiment, when the second device detection module 504 detects the media output device that is located under the same local area network with the remote control apparatus and meets the second precondition, a large number of network resources are also consumed to search all the media output devices within the local area network for the establishment of the data information transmission connection of the second data transmission link, and generally, the number of the target media output device desired by the user is also only one, or three at most. The establishment of the second data transmission link with all the media output devices searched within the local area network not only consumes a large number of network resources, but also even leads to network congestion to result in network delay. Based on this, for the purpose of efficiently detecting the media output device that is located under the same local area network with the remote control apparatus and meets the second precondition by the remote control apparatus, the remote control apparatus may detect the electronic device located under the same local area network with the remote control apparatus, judges whether the electronic device is the electronic device supporting the preset media transmission protocol and then acquires a second judgment result.

When the determination module 600 determines that the media output device meeting the second precondition is detected when the second judgment result indicates the electronic device being the electronic device supporting the preset media transmission protocol.

It should be noted that the first device detection module 501 and the second device detection module 504 in the present embodiment may be either two independent detection subunits in the detection module 500, or integrated into one detection unit for achieving different detection purposes. In the similar way, the first judgment module 502 and the second judgment module 505 may also be either two independent judgment subunits in the detection module 500, or integrated into one judgment unit for achieving different judgment purposes. The first result acquisition module 503 and the second result acquisition module 506 may be either two independent acquisition subunits in the detection module 500, or integrated into one acquisition unit for achieving different acquisition purposes. The present disclosure sets no limit to the specific setting means of an apparatus, and all those setting manners possible for achieving the object of the present disclosure shall fall within the protection scope of the present disclosure.

With application of the technical solution described above, the real-time high-speed detection of the target media output device, the establishment of the communication control connection of the first data transmission link corresponding to the target media output device and the establishment of the data information transmission connection of the second data transmission link corresponding to the target media output device can be implemented according to the present disclosure.

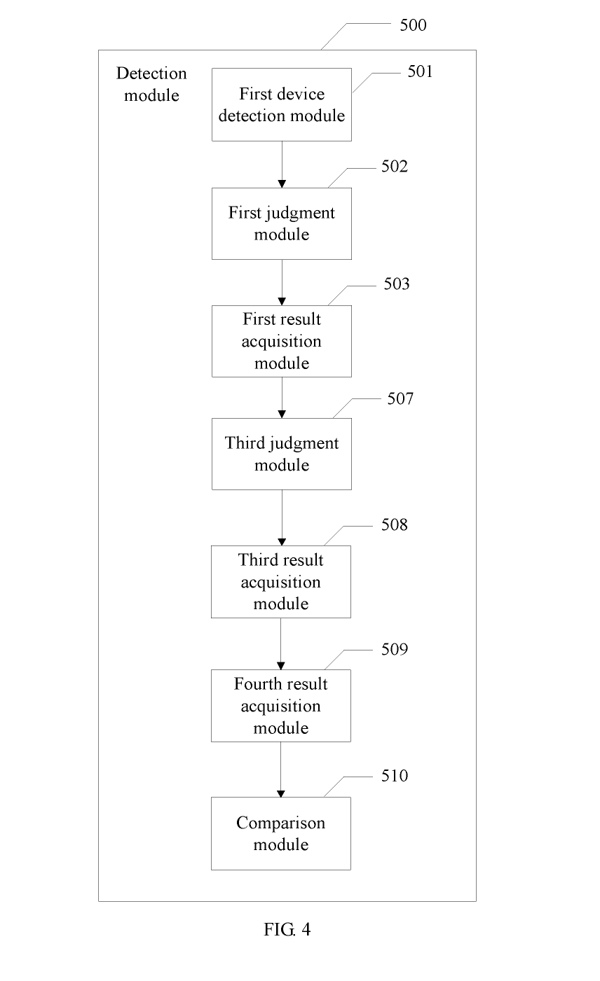

On the basis of the communication control connection of the first data transmission link established between the remote control apparatus and the media output device, in order to ensure that the data information transmission connection of the second data transmission link is established between the remote control apparatus and the same media output device simultaneously, it is desirable to ensure that the first and second data transmission links be established between the remote control apparatus and the media output device simultaneously. With reference to FIG. 4, there is provided a schematic diagram of another structure of a detection module according to the present disclosure, and the detection module includes a first device detection module 501, a first judgment module 502, a first result acquisition module 503, a third judgment module 507, a third result acquisition module 508, a fourth result acquisition module 509 and a comparison module 510. Wherein,

the first device detection module 501 is configured to detect an electronic device located under the same local area network with the remote control apparatus;

the first judgment module 502 is configured to judge whether the electronic device detected by the first device detection module 501 is a UPNP device with a preset identity;

the first result acquisition module 5003 is configured to acquire a first judgment result when the first judgment module 502 judges that the electronic device detected by the first device detection module 501 is a UPNP device with a preset identity;

the third judgment module 507 is configured to judge whether the detected electronic device located under the same local area network with the remote control apparatus is an electronic device supporting a preset media transmission protocol;

the third result acquisition module 508 is configured to acquire a third judgment result when the third judgment module 507 judges that the detected electronic device located under the same local area network with the remote control apparatus is an electronic device supporting a preset media transmission protocol;

the fourth result acquisition module 509 is configured to acquire a physical address of the detected UPNP device and a physical address of the electronic device supporting the preset media transmission protocol when the third judgment result indicates the electronic device being the electronic device supporting the preset media transmission protocol; and

the comparison module 510 is configured to compare whether the physical address of the UPNP device and the physical address of the electronic device supporting the preset media transmission protocol are the same.

Wherein, the determination module 600 is specifically configured to determine that the media output device meeting the precondition is detected simultaneously when the physical address of the UPNP device and the physical address of the electronic device supporting the preset media transmission protocol are the same under the comparison of the comparison module.

It should be noted that the media output device meeting the precondition is detected refers to that the media output device meeting the first and second preconditions simultaneously is detected.

In the present embodiment, according to the present disclosure, after a target media output device is firstly detected for establishment of a communication control connection of a first data transmission link, whether the target media output device is an electronic device supporting a preset media transmission protocol is judged continuously, and a data information transmission connection of a second data transmission link with the target media output device is further established. By further verifying the media transmission device detected, the media output device is determined as the target media output device when being the UPNP device and supporting the preset media transmission protocol simultaneously, thereby ensuring the accuracy in the simultaneous establishment of the first and second data transmission links with respect to the same media output device.

It should be noted that the present disclosure may also include that after a target media output device supporting a preset media transmission protocol is firstly detected for establishment of the data information transmission connection of the second data transmission link, whether the target media output device is a UPNP device is further judged continuously, and the data information transmission connection of the second data transmission link with the target media output device is established. The implementation of this process is similar to that of the embodiment described above; therefore, the applicant will not make illustration in details any more.

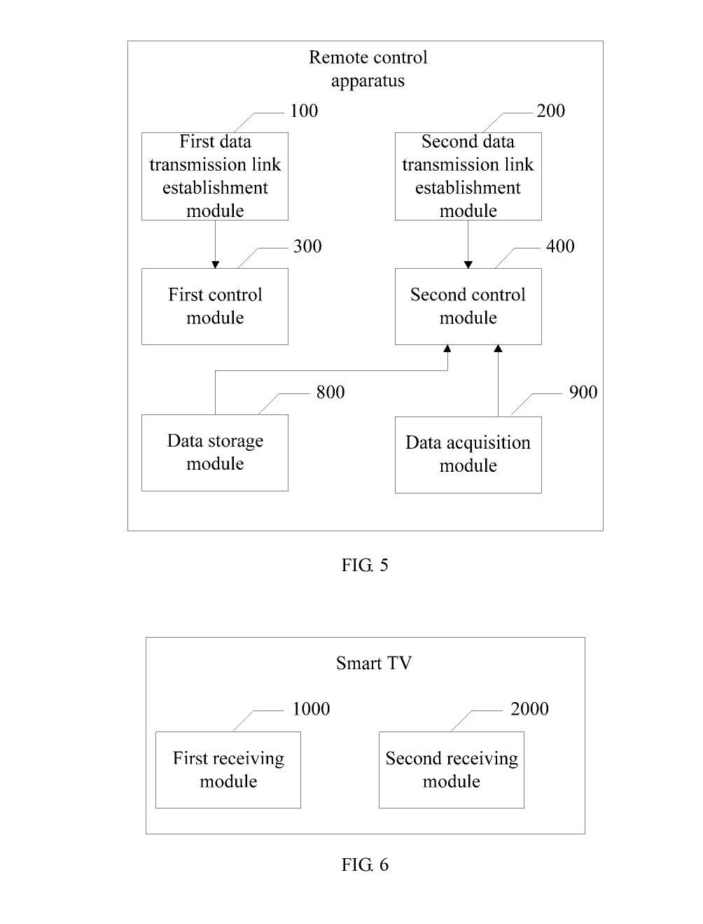

On the basis of the abovementioned embodiment, with reference to FIG. 5, there is provided a schematic diagram of further another structure of a remote control apparatus according to the present disclosure, and the remote control apparatus also includes a data storage module 800 and/or a data acquisition module 900. Wherein,

the data storage module 800 is configured to store data information of local resources of the remote control apparatus; and

the data acquisition module 900 is configured to acquire data information from a local area network.

In the present embodiment, a user may acquire data information stored in local resources of the remote control apparatus from the data storage module 800 and transmit the acquired data information to the target media transmission device by using the second data transmission link. The user may also acquire data information from the area network using the data acquisition module 900 and transmit the acquired data information to the target media transmission device by using the second data transmission link.

In addition, the data acquisition module 900 may also acquire a data link of the data information from the local area network and send the data link to the target media output device, so that the target media output device acquires the corresponding data information from Internet according to the data link after acquiring the data link.

With reference to FIG. 6, there is provided a schematic diagram of a structure of a smart TV according to the present disclosure, and the SMART TV includes a first receiving module 1000 and a second receiving module 2000.

Wherein, the first receiving module 1000 is configured to receive a control instruction from a remote control apparatus that is located under the same local area network with the smart TV. The control instruction is configured to control the smart TV to execute the control instruction after receiving the same.

Wherein, the control instruction may include at least one of a radio switching instruction, a volume adjusting instruction, a menu instruction, a determination instruction or a return instruction. For example, the smart TV is controlled in terms of radio selection, channel switching, volume adjusting, color or grayscale setting and the like.

The second receiving module 2000 is configured to receive data information from a remote control apparatus that is located under the same local area network with the smart TV. The data information is configured to allow the smart TV to output the data information after receiving the same.

Wherein, the data information may include at least one of picture information, video information or voice information. For example, video data, audio data, picture information and others stored in the remote control apparatus are transmitted to the smart TV, which continuously outputs the video data, audio data or picture information. It is also possible that video data, audio data, picture information and others acquired by the remote control apparatus from the Internet are transmitted to the smart TV, which further continuously outputs the video data, audio data or picture information.

In the present embodiment, specifically, the first receiving module 1000 is a UPNP module with a preset identity, and the second receiving module 2000 is a DLNA network protocol module.

The smart TV claimed by the present disclosure may not only fulfill the basic functions of video switching, playing and the like of a television simultaneously, but also receive and continuously output data information sent by the remote control apparatus, so as to fulfill the function of playing video, audio, picture information sent by the remote control apparatus, thereby giving more operation experience to the user.

It should be noted that, the embodiments in the present disclosure are disclosed progressively, each embodiment mainly emphasis the differences from other embodiments, the similar part between different embodiments may be referred to each other. The various device embodiments correspond to the method embodiments, therefore the description is relatively simple, the related parts may be referred to the method embodiments.

At last, it should be noted that, in the present disclosure, the relational terms such as the first and the second are merely used to separate one entity from another entity, rather than requiring or implying practical relation or sequence of these entities and procedures. In addition, the term include or include or variant forms thereof represents the is of including but not limiting, thusly the process, method, product or apparatus which includes essentials may not only include those essentials, but also include other essentials which are not listed definitely, or may include the initial essentials of the process, method, product or apparatus. In the case that no more limitation is given, the essentials limited by the term “including” does not preclude other same or similar essentials exist in the process, method, product or apparatus.

The remote control apparatus and smart TV provided in the present disclosure are described in detail, specific case are used in the present disclosure to illustrate the principle of the present disclosure, the illustration of the embodiments is just for helping understanding the method and core concept of the present disclosure, meanwhile, for one of ordinary skill in the art, according to the thought of the present disclosure, the specific embodiments and applications may be changed, to sum up, the description should not be understood as the restriction to the present disclosure.

1. A remote control apparatus applied to smart control area, comprising:
a memory having instructions stored thereon;
a processor configured to execute the instructions to perform operations, comprising:
establishing a communication control connection between the remote control apparatus and a media output device that is located under a same local area network with the remote control apparatus and meets a first precondition;
establishing a data information transmission connection between the remote control apparatus and a media output device that is under a same local area network with the remote control apparatus and meets a second precondition;
sending a control instruction to the media output device by using an established first data transmission link corresponding to the media output device so as to control the media output device to execute the control instruction; and
sending data information to the media output device by using an established second data transmission link corresponding to the media output device so as to allow the media output device to output the data information after receiving the same.

2. The remote control apparatus according to claim 1, wherein the processor is further configured to perform:
detecting the media output device that is located under the same local area network with the remote control apparatus and meets the first or second precondition;
determining at least one of the media output devices detected as a target media output device; and
acquiring device information of the target media output device, the device information at least comprising a physical address of the target media output device,
wherein in the establishing a communication control connection between the remote control apparatus and a media output device that is located under a same local area network with the remote control apparatus and meets a first precondition, a communication control connection request is sent to the target media output device by using the physical address of the target media output device, contained in the acquired device information, so as to establish a first data transmission link with the target media output device; and
in the establishing a data information transmission connection between the remote control apparatus and a media output device that is under a same local area network with the remote control apparatus and meets a second precondition, a data information transmission connection request is sent to the target media output device by using the physical address of the target media output device, contained in the acquired device information, so as to establish the second data transmission link with the target media output device.

3. The remote control apparatus according to claim 2, wherein the processor is further configured to perform:
detecting an electronic device located under the same local area network with the remote control apparatus;
judging whether the detected electronic device detected is a universal plug and play (UPNP) device with a preset identity; and
acquiring a first judgment result when the detected electronic device is judged to be is a UPNP device with a preset identity,
wherein the processor is further configured to determine that a media output device meeting a precondition is detected when the first judgment result indicates the electronic device being the UPNP device.

4. The remote control apparatus according to claim 2, wherein the processor is further configured to perform:
detecting an electronic device located under the same local area network with the remote control apparatus;
judging whether the detected electronic is an electronic device supporting a preset media transmission protocol; and
acquiring a second judgment result when the detected electronic device located under the same local area network with the remote control apparatus is judged to be an electronic device supporting a preset media transmission protocol;
wherein in the determining at least one of the media output devices detected as a target media output device, a media output device meeting a precondition is detected when the second judgment result indicates the electronic device being the electronic device supporting the preset media transmission protocol.

5. The remote control apparatus according to claim 3, wherein the processor is further configured to performs:
judging whether the detected electronic device located under the same local area network with the remote control apparatus is an electronic device supporting a preset media transmission protocol;
acquiring a third judgment result when the detected electronic device located under the same local area network with the remote control apparatus is judged to be an electronic device supporting a preset media transmission protocol;
acquiring a physical address of the detected UPNP device and a physical address of the electronic device supporting the preset media transmission protocol when the third judgment result indicates the electronic device being the electronic device supporting the preset media transmission protocol; and
comparing whether the physical address of the UPNP device and the physical address of the electronic device supporting the preset media transmission protocol are the same,
wherein in the determining at least one of the media output devices detected as a target media output device, a media output device meeting a precondition is detected when the physical address of the UPNP device and the physical address of the electronic device supporting the preset media transmission protocol are the same.

6. The remote control apparatus according to claim 1, wherein the processor is further configured to perform:
storing data information of local resources of the remote control apparatus;
or
acquiring data information from a local area network.

7. The remote control apparatus according to claim 1, wherein the control instruction may be at least one of a radio switching instruction, a volume adjusting instruction, a menu instruction, a determination instruction or a return instruction.

8. The remote control apparatus according to claim 1, wherein the data information may comprise at least one of picture information, video information or voice information.

9. A smart TV applied to smart control area, comprising:
a first receiving module, which is configured to receive a control instruction from a remote control apparatus that is located under the same local area network with the smart TV, the control instruction being configured to control the smart TV to execute the control instruction after receiving the same; and
a second receiving module, which is configured to receive data information from a remote control apparatus that is located under the same local area network with the smart TV, the data information being configured to allow the smart TV to output the data information after receiving the same.

10. The smart TV according to claim 9, wherein
the first receiving module is a UPNP module with a preset identity; and
the second receiving module is a Digital Living Network Alliance (DLNA) network protocol module.

11. The remote control apparatus according to claim 2, wherein the processor is further configured to perform:
storing data information of local resources of the remote control apparatus;
or
acquiring data information from a local area network.

12. The remote control apparatus according to claim 3, wherein the processor is further configured to perform:
storing data information of local resources of the remote control apparatus;
or
acquiring data information from a local area network.

13. The remote control apparatus according to claim 4, wherein the processor is further configured to perform:
storing data information of local resources of the remote control apparatus;
or
acquiring data information from a local area network.

14. The remote control apparatus according to claim 5, wherein the processor is further configured to perform:
storing data information of local resources of the remote control apparatus;
or
acquiring data information from a local area network.
